(19) United States
(12) Patent Application Publication
(10) Pub. No.: US 2008/0002909 A1
(43) Pub. Date: Jan. 3, 2008

(54) Reconstructing Blurred High Resolution Images

(75) Inventors: Yanghai Tsin, Plainsboro, NJ (US); Yakup Genc, Dayton, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH, INC., PRINCETON, NJ (US)

(21) Appl. No.: 11/695,119

(22) Filed: Apr. 2, 2007

Related U.S. Application Data
(60) Provisional application No. 60/818,377, filed on Jul. 3, 2006.

(51) Int. Cl. G06K 9/40

(52) U.S. Cl. 382/275

(57) ABSTRACT

A method of generating a resulting image includes generating a superimposed image by aligning and superimposing one or more transposed images with a reference image by using offsets of the one or more transposed images from the reference image, generating an intermediate image from the superimposed image, generating a new superimposed image by aligning and superimposing the intermediate image, the one or more transposed images and the reference image by using offsets of the one or more transposed images and the reference image from the intermediate image, and generating a resulting image from the new superimposed image.

### CROSS-REFERENCE TO RELATED APPLICATIONS

This application claims priority to U.S. Provisional Application No. 60/818,377, filed on Jul. 3, 2006, the disclosure of which is incorporated by reference herein.

### BACKGROUND OF THE INVENTION

1. Technical Field

The present disclosure relates generally to the field of imaging, and, more particularly, to the generation of high-resolution images from low-resolution images.

2. Discussion of the Related Art

A conventional imaging system, such as a digital camera, includes a lens and charge-coupled devices (CCD) to capture an image of a scene viewed by the naked eye. However, the captured image is really only an approximation of the scene because the capture process introduces both optical and electrical blurring. During the capture process, input rays from the scene enter through the lens of the camera and are blurred by the imperfections in the lens, resulting in optical blurring. The blurred rays are then integrated by a process known as spatial integration over a region corresponding to the receptive field of a CCD well. The CCD is an image sensor which includes an integrated circuit with an array of linked or coupled, light sensitive capacitors. Each unit of the array is responsible for capturing a measure of the light representative of the area of the unit. Accordingly, the resolution of the captured image is limited and is illustrated by way of the following example. Assume that light over an upper half of a single unit of the array corresponds to an intensity of 200 out of 255, and light at a lower half corresponds to an intensity of 100 out of 255. Since the single unit of the array cannot capture both intensities (i.e., 100 and 200), an averaging may be performed, resulting in electrical blurring.

The combined effect of optical blur and spatial integration is modeled by a point spread function (PSF). Due to the low pass filtering effect of PSF, frequency components higher than a certain threshold are irrevocably lost. Attempts to recover high frequency components have been shown to be ill-posed.

Conventional studies show that the condition number (i.e. the measure of a problem's amenability to digital computation) of a related linear system of equations increases at least quadratically with the magnification factor and the practical magnification factor is below 2.

Any further recovery of high frequency components is due to subjective priors which introduce artificial information. For higher magnification factors, the high frequency component has to be hallucinated or learned from a large set of natural images.

Other regularization methods include forcing some prior knowledge, such as smoothness, into the reconstructing process. While it may be satisfactory to impose these subjective criteria on super-resolution problems when visualization is the sole purpose, it can be quite dangerous for accuracy demanding tasks in medical and industrial applications. In such applications, nothing but the original signal matters and introducing any biased prior could result in catastrophe.

Thus, there is a need for a system and method of improving image resolution that does not introduce subjective priors.

### SUMMARY OF THE INVENTION

According to an exemplary embodiment of the present invention, a method of generating an image is provided. The method includes the steps of generating a superimposed image by aligning and superimposing one or more transposed images with a reference image by using offsets of the one or more transposed images from the reference image, generating an intermediate image from the superimposed image, generating a new superimposed image by aligning and superimposing the intermediate image, the one or more transposed images and the reference image by using offsets of the one or more transposed images and the reference image from the intermediate image, and generating a resulting image from the new superimposed image.

The method may further include the step of using the resulting image to perform one of edge detection, corner detection, or object recognition. The offsets may be linear or rotational offsets. A first resolution of the reference image and the transposed images may be substantially the same. A second resolution of the resulting image may be greater than the first resolution. The offsets may be a fractional unit of the first resolution.

The step of generating the intermediate image from the superimposed image may further include the steps of sub-dividing the superimposed image into substantially equal regions, assigning a region intensity to each of the regions based on intensities of neighboring pixels of the superimposed image, and generating the intermediate image from the regions. Alternately, the subdividing can be performed only on a portion of the superimposed image. The step of assigning the region intensity to each of the regions based on intensities of neighboring pixels of the superimposed image may further include the steps of generating a list of weighted intensities for each of the regions and generating the region intensity by averaging the list of weighted intensities for the region. Each of the weighted intensities may correspond to an intensity of one of the neighboring pixels that is weighted as a function of a distance between the region and the neighboring pixel.

According to an exemplary embodiment of the present invention, a program storage device readable by machine, tangibly embodying a program of instructions executable by the machine to perform method steps for generating an image is provided. The method steps include generating a superimposed image by aligning and superimposing one or more transposed images with a reference image by using offsets of the one or more transposed images from the reference image, generating an intermediate image from the superimposed image, generating a new superimposed image by aligning and superimposing the intermediate image, the one or more transposed images and the reference image by using offsets of the one or more transposed images and the reference image from the intermediate image, and generating a resulting image from the new superimposed image.

According to an exemplary embodiment of the present invention, an imaging system is provided that includes an image collection module, an image registration module, and an image composition module. The imaging collection module may capture images using various technologies, such as, for example, CCD, super CCD, 3CCD, frame transfer CCD, electron-multiplying CCD(EMCCD), intensified CCD (ICCD), CMOS, photodiode, contact images sensor (CIS), etc. The image collection module collects a plurality of transposed images. The plurality of transposed images are offset from one of the transposed images by corresponding transposed offsets. The image registration module determines the corresponding transposed offsets to be stored as registration parameters. The image composition module generates a current image from the transposed images and iteratively generates a subsequent image from the current image and the transposed images while a difference between the registration parameters and new registration parameters is greater than a predefined amount and outputs the subsequent image when the difference is less than or equal to the predefined amount. The new registration parameters are determined by the registration module from new transposed offsets between the transposed images and the current image.

According to an exemplary embodiment of the present invention, a method of generating a region of a higher resolution image is provided. The method includes the steps of receiving dimensions of a higher resolution image, selecting pixel locations of a region of interest from the dimensions of the higher resolution image, generating intensity values of each pixel in the region of interest in the higher resolution image by using the corresponding offsets, and outputting the intensity values. The higher resolution image is derived from a reference image and one or more images transposed from the reference image by corresponding offsets. The intensity values may be used to perform one of edge detection, corner detection, or object recognition.

### BRIEF DESCRIPTION OF THE DRAWINGS

The invention may be understood by reference to the following description taken in conjunction with the accompanying drawings, in which like reference numerals identify like elements, and in which:

FIG. 1 is a high-level block diagram of a system that enhances image resolution according to an exemplary embodiment of the present invention;

FIG. 2 illustrates a method of enhancing image resolution, according to an exemplary embodiment of the present invention;

FIG. 3 illustrates a method of combining low-resolution images according to an exemplary embodiment of the present invention;

FIG. 4 illustrates a method for determining intensity of a high-resolution pixel, according to an exemplary embodiment of the present invention;

FIG. 5 illustrates a pixel mosaic of a reference image and a single transposed image, and resulting high-resolution pixels, according to an exemplary embodiment of the present invention;

FIGS. 6a and 6b illustrate conventional edge detection methods;

FIG. 6c illustrates an edge detection method according to an exemplary embodiment of the present invention;

FIG. 7a illustrates a conventional corner detection method;

FIG. 7b illustrates a corner detection method according to an exemplary embodiment of the present invention;

FIG. 8a and FIG. 8b illustrate magnification of a standard image; and

FIG. 8c illustrates magnification of a blurred high-resolution image generated from the standard image according to an exemplary embodiment of the present invention.

### DETAILED DESCRIPTION OF EXEMPLARY EMBODIMENTS

In general, exemplary embodiments of the invention as described in further detail hereafter include systems and methods which improve image resolution without introducing subjective priors.

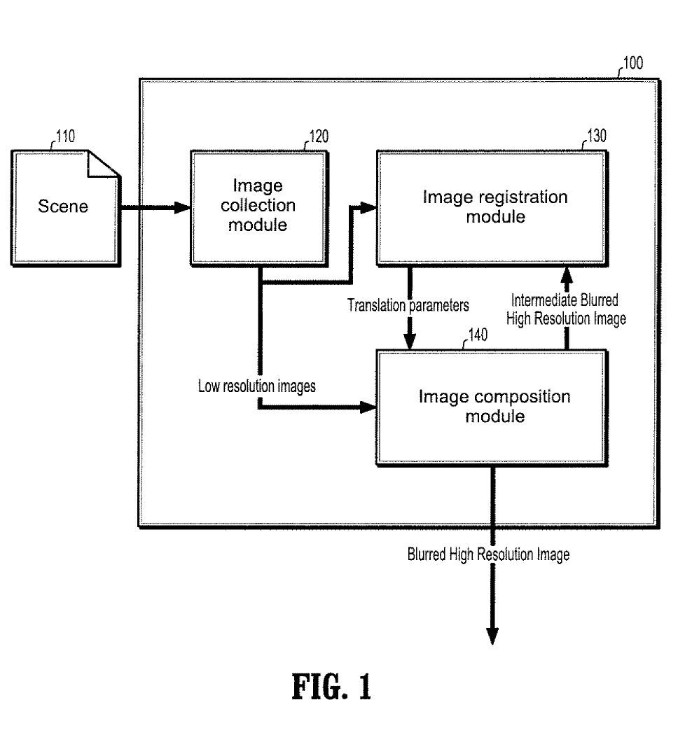

Exemplary systems and methods which improve image resolution without introducing subjective priors will now be discussed in further detail with reference to illustrative embodiments of FIGS. 1-7. It is to be understood that the systems and methods described herein may be implemented in various forms of hardware, software, firmware, special purpose processors, or a combination thereof. In particular, at least a portion of the present invention is preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying figures are preferably implemented in software, the connections between system modules (or the logic flow of method steps) may differ depending upon the manner in which the present invention is programmed. Given the teachings herein, one of ordinary skill in the related art will be able to contemplate these and similar implementations of the present invention.

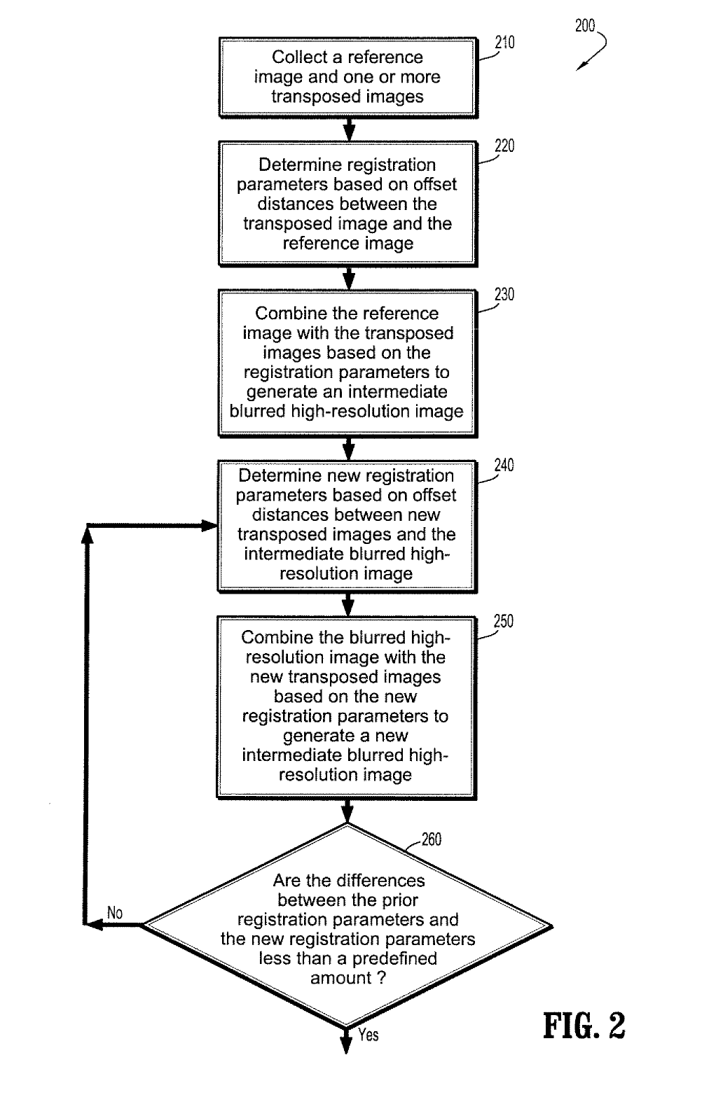

FIG. 1 is a high-level block diagram of a system 100 that enhances image resolution according to an exemplary embodiment of the present invention. FIG. 2 illustrates a method of enhancing image resolution, according to an exemplary embodiment of the present invention, that will be discussed with respect to FIG. 1.

Referring to FIG. 1, the system 100 includes an image collection module 120, and image registration module 130, and an image composition module 140. Referring to FIG. 1 and 2, the image collection module 120 collects low-resolution images of an external scene 110 in a first step 210. The imaging collection module 120 may collect the low-resolution images using various technologies, such as, for example, CCD, super CCD, 3CCD, frame transfer CCD, electron-multiplying CCD(EMCCD), intensified CCD (ICCD), CMOS, photodiode, contact images sensor (CIS), etc. The low-resolution images include a reference image and one or more transposed images.

It is preferred that the resolution of the images be substantially similar to one another. The reference image represents a section of the external scene 110. The transposed images are similar to the reference image but are translated or rotated with respect to the reference image by predetermined offset distances. It is preferred that the predetermined offset distances be a fractional pixel offset and be small relative to the size of the resolution of the images. For example, if the resolution of the images were 500×500 pixels, an exemplary offset could be 0.5 pixels, 1.5 pixels, 2.5 pixels, etc.

Referring to FIGS. 1 and 2, the image registration module 130 determines the offsets distances between the transposed images and the reference image and outputs the offset distances as registration parameters to the image composition module 140 in a step 220. The registration parameters may be saved by the system 100 for later use.

The image composition module 140 combines the reference image with the transposed images based on the registration parameters to generate an intermediate blurred high resolution image in a step 230.

The resulting intermediate blurred high-resolution image is fed back to the image registration module 130. The original reference image is added to the transposed images to generate new transposed images and the resulting intermediate blurred high-resolution image becomes a new reference image. The image registration module 130 determines new offsets distances between the new transposed images and the intermediate blurred high-resolution image (i.e., the new reference image) to generate new registration parameters in a step 240 for output to the image composition module 140.

The image composition module combines 140 the new intermediate blurred high-resolution image with the new transposed images based on the new registration parameters in a step 250 to generate a new intermediate blurred high-resolution image. The new intermediate blurred high-resolution image is output by the image composition module 140 if it is determined that the change between the registration parameters and the new registration parameters in a step 260 is less than a predefined parameter. However, if the change is larger than the predefined parameter, the new intermediate blurred high-resolution becomes the new reference image and the method 200 illustrated in FIG. 2 is repeated until the differences are less than the predefined parameter.

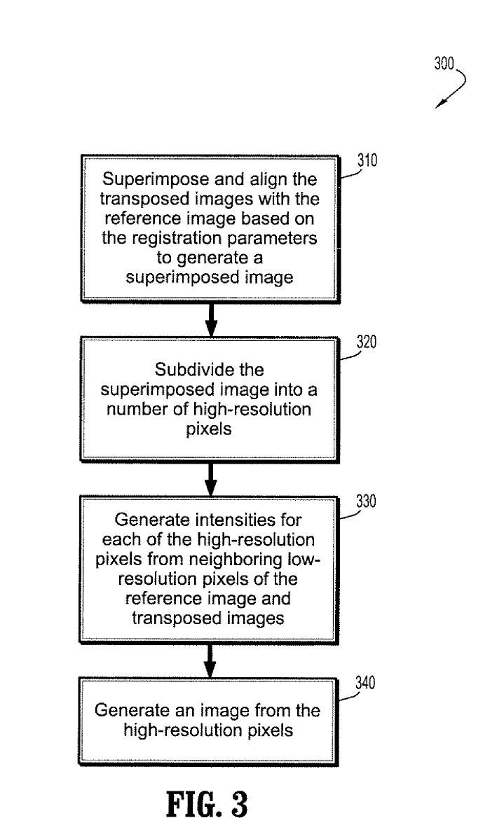

The combining of a reference image with transposed images illustrated in steps 230 and 250 are illustrated in greater detail in FIG. 3 as a method of combining low-resolution images, according to an exemplary embodiment of the present invention.

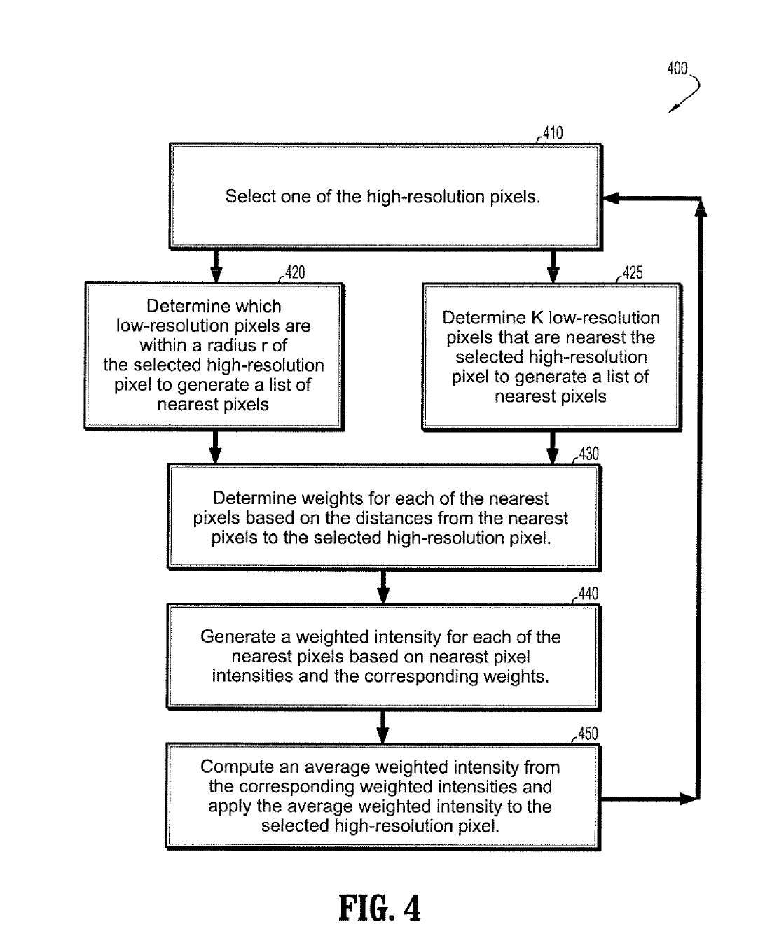

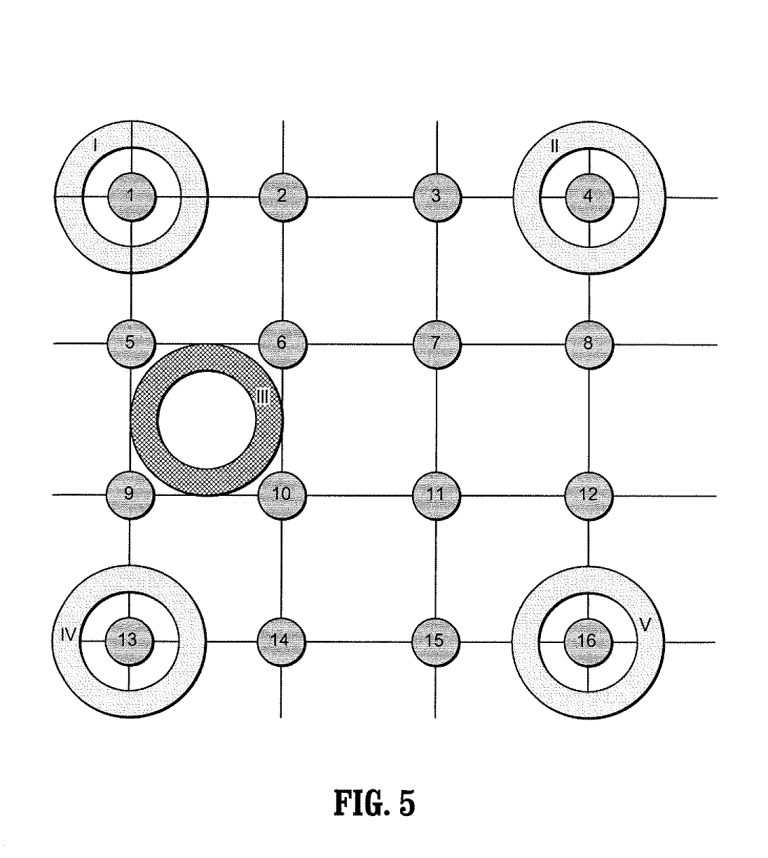

Referring to FIG. 3, the transposed images are superimposed and aligned on the reference image based on the registration parameters to generate a superimposed image in a step 310. Then, either a portion of the superimposed image or the entire superimposed image is subdivided into a number of high-resolution pixels in a step 320. When only a portion of the superimposed image is likely to be of interest, it is more efficient to operate on that portion alone, rather than operate on the entire superimposed image. The number is preferred to be greater than the resolution of the transposed images. For example, if a resolution of the transposed images is 4×4, the number could be 32, 64, etc. Next, intensities for each of the high-resolution pixels are determined from neighboring pixels of the reference image and transposed images in a step 330. An example of how to determine the intensity for a high-resolution pixel is illustrated in FIG. 4 and FIG. 5.

FIG. 4 illustrates a method 400 for determining the intensity of a high-resolution pixel, according to an exemplary embodiment of the present invention. FIG. 5 illustrates a pixel mosaic of a reference image and a single transposed image, and resulting high-resolution pixels.

Referring to FIG. 5, low-resolution pixels of the reference image are represented by annuli I, II, IV, and IV. A low-resolution pixel of a transposed image is represented by annulus III. The high-resolution pixels are represented by circles 1-16.

Referring to FIG. 4, one of the high-resolution pixels is selected in a step 410. For example, assume that high-resolution pixel 5 has been selected. Next, it is determined which of the low-resolution pixels are within a radius r of the selected high-resolution pixel in a step 420 to generate a list of nearest pixels. Alternately, a number K of low-resolution pixels nearest the selected high-resolution pixel can be determined to generate the list of nearest pixels in a step 425. For example, if K=2, then the list of nearest pixels includes annulus I from the reference image and annulus III from the transposed image.

Next, weights are determined for each of the nearest pixels based on their relative distances from the nearest pixels to the selected high-resolution pixel in a step 430. The further away a nearest pixel is from a high-resolution pixel, the less influence it should have. Accordingly, the weight of a closer nearest pixel is higher than the weight of a further nearest pixel. For example, since annulus III is fairly close to high-resolution pixel 5, assume a weight of 0.9 for annulus III. Further assume a weight of 0.2 for annulus I because annulus I is further away from high-resolution pixel 5.

Next, a weighted intensity is generated for each of the nearest pixels based on intensities of the nearest pixels and the corresponding weights in a step 440. For example, assume that the intensity of the pixel represented by annulus I is 100 and the intensity of the pixel represented by annulus III is 120. The weighted intensity of the pixel represented by annulus I would be 20 (i.e., 100×0.2) and the weighted intensity of the pixel represented by annulus III would be 108 (i.e., 120×0.9).

Next the average weighted intensity is computed from the corresponding weighted intensities and applied to the selected high-resolution pixel in a step 450. For example, the average weighted intensity of high-resolution pixel 5 may be computed by summing the weighted intensities (i.e., 20+108=128), summing the weights (i.e., 0.2+0.9=1.1), and dividing the summed weighted intensities by the summed weights (i.e., 128/1.1) to generate an average weighted intensity of 116 for high-resolution pixel 5. The method 400 illustrated in FIG. 4 is executed for each of the high-resolution pixels.

It is to be understood that although only one transposed image is illustrated in FIG. 5, the method 400 of FIG. 4 can be applied to any number of transposed images. In fact, the clarity of the resulting image improves as the number of transposed images increases. However, when the number of transposed increases beyond a certain point, there is likely to be redundant information. Accordingly, the optimal number of transposed images depends on various factors and may be determined through experimentation. Further, while the method 400 has been discussed with respect to determining intensity, which would suggest a monochrome color, the method 400 can also be used to determine a color of a high-resolution pixel by applying the method 400 separately to each red, green, and blue component.

The resulting blurred high-resolution image output by the image composition module 140 has a higher resolution than the original reference image and may provide information necessary for high accuracy localization of image features during edge detection and corner detection.

The goal of edge detection is to mark the points in a digital image at which the luminous intensity changes sharply. Sharp changes in image properties usually reflect important events and changes in properties of the world.

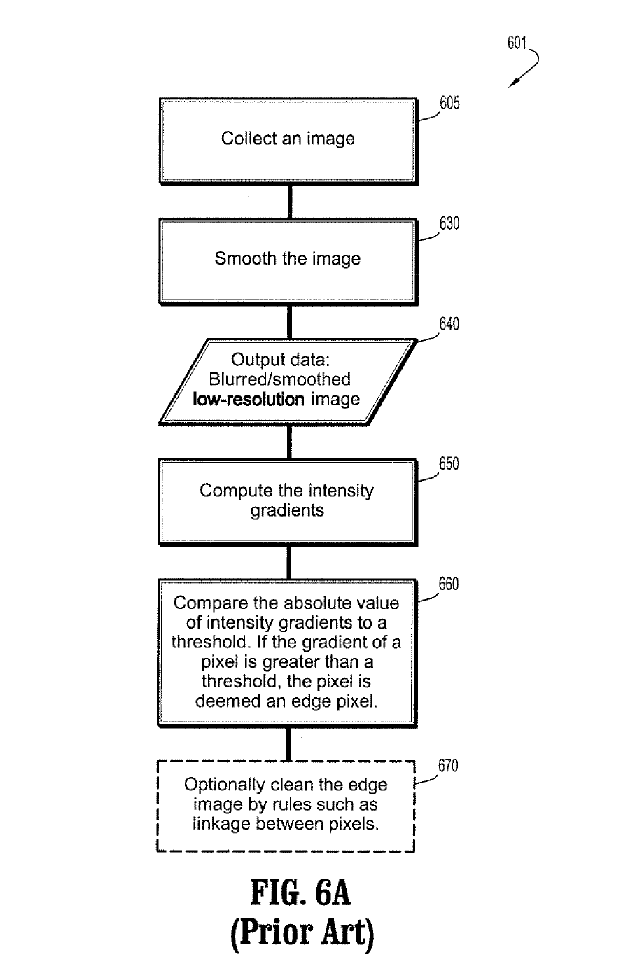

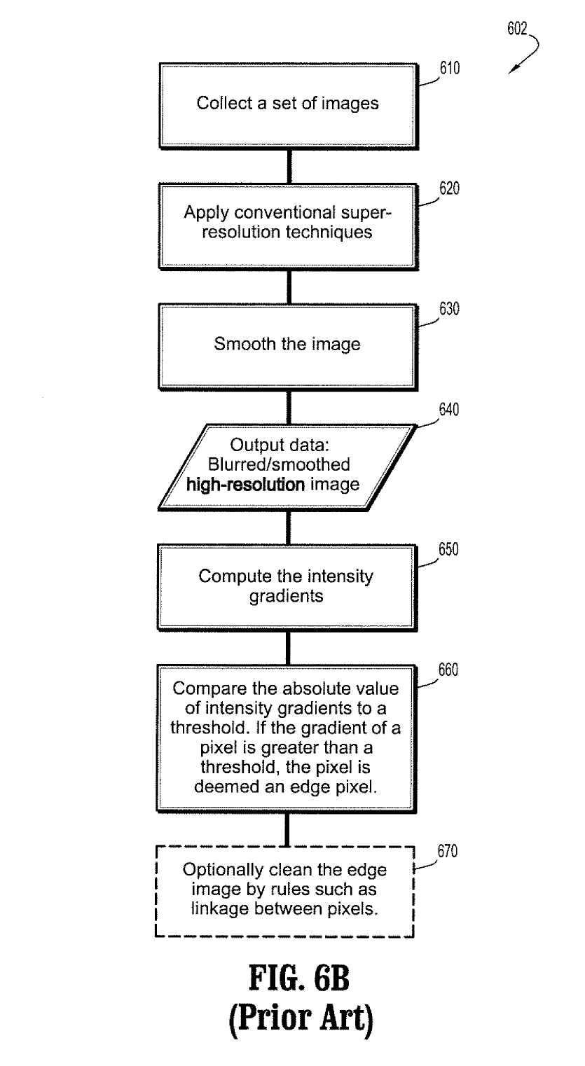

FIGS. 6a and 6b illustrate conventional edge detection methods 601 and 602. Referring to FIG. 6a, a low-resolution image is first collected in a step 605. Referring to FIG. 6b, a set of low-resolution images is first collected in a step 610 and a conventional super-resolution technique is applied to the set of low-resolution images in a step 620. The methods 601 and 602, then continue by smoothing the resulting image in a step 630, resulting in a blurred and smoothed image in a step 640. Next, intensity gradients (i.e., the rate of intensity change) of the blurred and smoothed image are computed in a step 650. Next, in a step 660, the absolute value of intensity gradients are compared to a threshold value, and if the gradient of a pixel is greater than the threshold, the pixel is deemed an edge pixel. Optionally, in a step 670, an edge image that is generated from the edge pixels may cleaned by linking rules which link edge pixels together.

The first conventional edge detection method 601 produces an image with low-resolution and low accuracy. While the second convention edge detection method 602 produces an image with high-resolution, the method 602 may also introduce subjective priors into the image because the method 602 relies on conventional super-resolution techniques. FIG. 6c illustrates an edge detection method 603, according to an exemplary embodiment of the present invention. Referring to FIG. 6c, the method 603 begins by executing the method 200 of FIG. 2 and then continues by executing the common steps 640-670 illustrated in the methods 601 and 602 of FIGS. 6a and 6b. The method 603 produces an image of high-resolution image, but also having a high accuracy since the method 200 does not introduce subjective priors into the image.

Corner detection is an approach used to extract certain kinds of features for inferring the contents of an image. Corner detection is also known as interest point detection. An interest point is a point in an image which has a well-defined position and can be robustly detected.

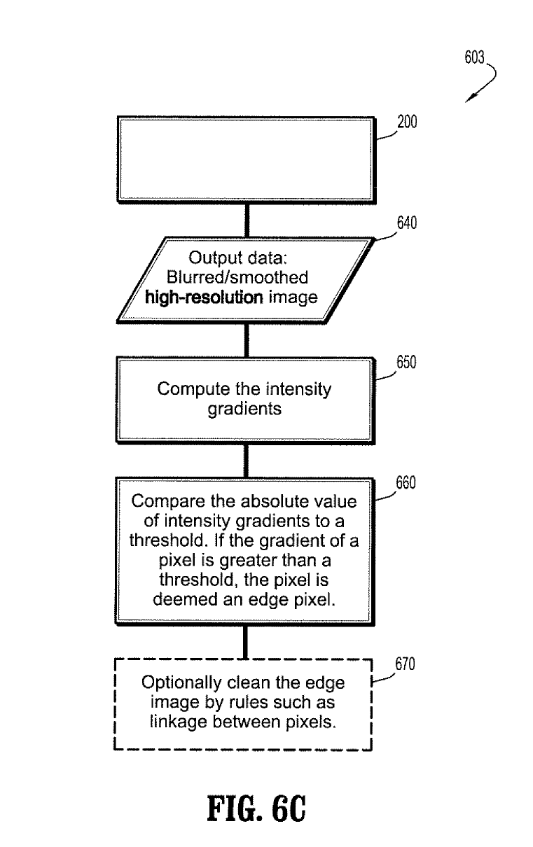

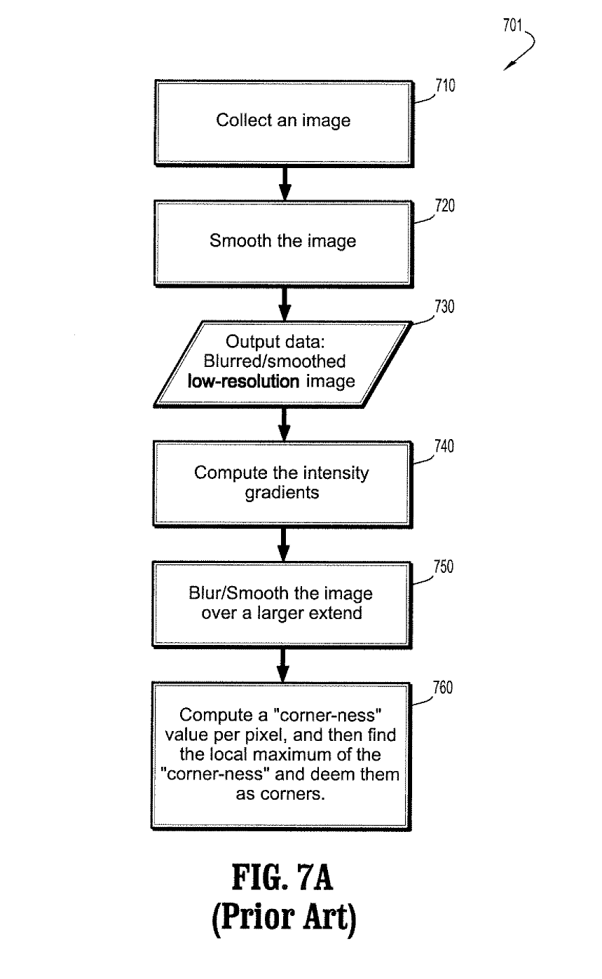

FIG. 7a illustrates a conventional corner detection method. Referring to FIG. 7a, an image is collected in a step 710 and smoothed in a step 720. Next a blurred, smoothed image is output in an step 730. Next, intensity gradients of the image are computed in a step 740 and the image is blurred and smoothed over a larger extend. Finally, a “corner-ness” value per pixel is computed, and a local maximum of the “corner-ness” values is determined and deemed as a corner or point of interest.

FIG. 7b illustrates a corner detection method according to an exemplary embodiment of the present invention. The method 702 operates on multiple low-resolution images and begins by executing the method 200 illustrated in FIG. 2 and continues by executing the commons steps 730-760 of the method 701 illustrated in FIG. 7a. While the convention method 701 illustrated in FIG. 7a results in an image having low-resolution and low accuracy, the method 702 illustrated in FIG. 7b results in an image having a high-resolution and high accuracy.

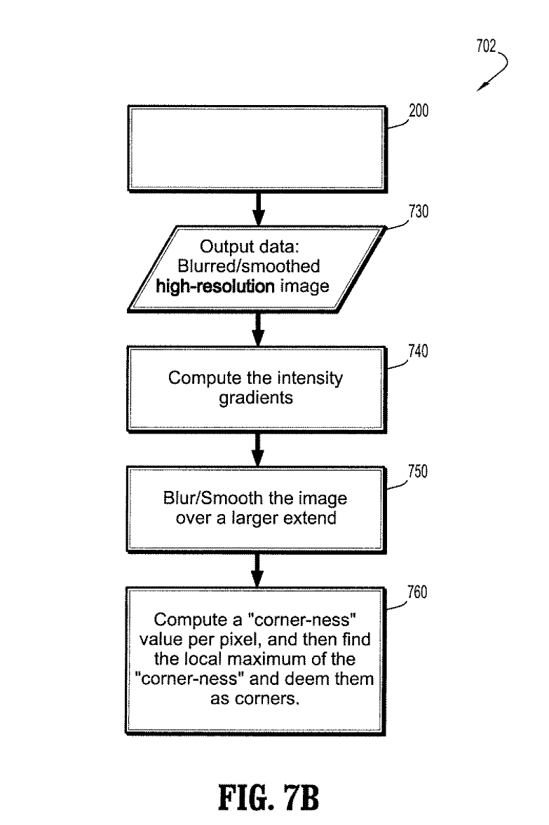

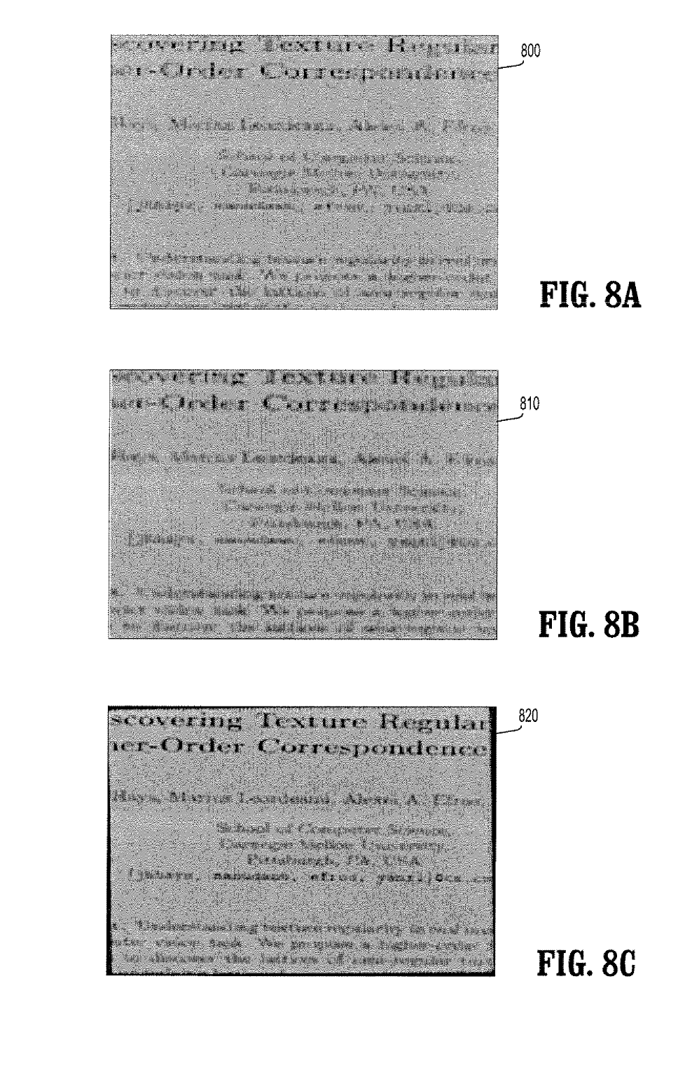

FIGS. 8a and 8b illustrate images 810 and 820 that were generated by digitally magnifying an original image ten times using nearest neighbor and bilinear interpolation techniques, respectively. The original image was captured using a Cannon Powershot Digital Elph S410 digital camera. Due to severe undersampling, text at the bottom of the image is hardly recognizable. The image 820 illustrated in FIG. 8c, which is clearly a great improvement over the results illustrated in FIGS. 8a and 8b, was generated by digitally magnifying a blurred high-resolution image that was generated from the original image according to at least one embodiment of the present invention.

Although the exemplary embodiments of the present invention have been described in detail with reference to the accompanying drawings for the purpose of illustration, it is to be understood that the that the inventive processes and systems are not to be construed as limited thereby. It will be readily apparent to those of ordinary skill in the art that various modifications to the foregoing exemplary embodiments can be made therein without departing from the scope of the invention as defined by the appended claims, with equivalents of the claims to be included therein.

What is claimed is:

1. A method of generating an image, comprising:
generating a superimposed image by aligning and superimposing one or more transposed images with a reference image by using offsets of the one or more transposed images from the reference image;
generating an intermediate image from the superimposed image;
generating a new superimposed image by aligning and superimposing the intermediate image, the one or more transposed images and the reference image by using offsets of the one or more transposed images and the reference image from the intermediate image; and
generating a resulting image from the new superimposed image.

2. The method of claim 1, further comprising:
using the resulting image to perform one of edge detection, corner detection, or object recognition,

3. The method of claim 1, wherein the offsets are linear offsets.

4. The method of claim 1, wherein the offsets are rotational offsets.

5. The method of claim 1, wherein a first resolution of the reference image and the transposed images are substantially the same.

6. The method of claim 5, wherein a second resolution of the resulting image is greater than the first resolution.

7. The method of claim 5, wherein the offsets are a fractional unit of the first resolution.

8. The method of claim 1, wherein the generating of an intermediate image from the superimposed image comprises:
sub-dividing the superimposed image into substantially equal regions;
assigning a region intensity to each of the regions based on intensities of neighboring pixels of the superimposed image; and
generating the intermediate image from the regions.

9. The method of claim 8, wherein the assigning of a region intensity to each of the regions based on intensities of neighboring pixels of the superimposed image comprises:
generating a list of weighted intensities for each of the regions, wherein each of the weighted intensities corresponds to an intensity of one of the neighboring pixels that is weighted as a function of a distance between the region and the neighboring pixel; and
generating the region intensity by averaging the list of weighted intensities for the region.

10. The method of claim 1, wherein the generating of an intermediate image from the superimposed image superimposed image comprises:
sub-dividing the superimposed image into substantially equal regions;
assigning a region color to each of the regions based on colors of neighboring pixels of the superimposed image; and
generating the intermediate image from the regions.

11. The method of claim 8, wherein the neighboring pixels are selected from pixels of the superimposed image that are within a certain radius of a corresponding one of the regions.

12. The method of claim 8, wherein the neighboring pixels are a number of pixels of the superimposed image that are closest to a corresponding one of the regions.

13. The method of claim 1, wherein the generating of a resulting image from the new superimposed image comprises:
sub-dividing the new superimposed image into substantially equal regions;
assigning a region intensity to each of the regions based on intensities of neighboring pixels of the new superimposed image; and
generating the resulting image from the regions.

14. A program storage device readable by machine, tangibly embodying a program of instructions executable by the machine to perform method steps for generating an image, the method steps comprising:
generating a superimposed image by aligning and superimposing one or more transposed images with a reference image by using offsets of the one or more transposed images from the reference image;
generating an intermediate image from the superimposed image;
generating a new superimposed image by aligning and superimposing the intermediate image, the one or more transposed images and the reference image by using offsets of the one or more transposed images and the reference image from the intermediate image; and
generating a resulting image from the new superimposed image.

15. The program storage device of claim 14, the method further comprising:
using the resulting image to perform one of edge detection, corner detection, or object recognition.

16. The program storage device of claim 14, wherein the generating of an intermediate image from the superimposed image comprises:
sub-dividing the superimposed image into substantially equal regions;
assigning a region intensity to each of the regions based on intensities of neighboring pixels of the superimposed image; and
generating the intermediate image from the regions.

17. The program storage device of claim 15, wherein the generating of a resulting image from the new superimposed image comprises:
sub-dividing the new superimposed image into substantially equal regions;
assigning a region intensity to each of the regions based on intensities of neighboring pixels of the new superimposed image; and
generating the resulting image from the regions.

18. An imaging system, comprises:
an image collection module to collect a plurality of transposed images, wherein the plurality of transposed images are offset from one of the transposed images by corresponding transposed offsets;
an image registration module to determine the corresponding transposed offsets to be stored as registration parameters; and
an image composition module to generate a current image from the transposed images and to iteratively generate a subsequent image from the current image and the transposed images while a difference between the registration parameters and new registration parameters is greater than a predefined amount and to output the subsequent image when the difference is less than or equal to the predefined amount,
wherein the new registration parameters are determined by the registration module from new transposed offsets between the transposed images and the current image.

19. The image system of claim 18, wherein the current image comprises a plurality of pixels that are each derived from corresponding neighboring pixels of a superposition of the transposed images.

20. The image system of claim 18, wherein the subsequent image comprises a plurality of pixels that are each derived from corresponding neighboring pixels of a superposition of the transposed images and the current image.

21. The image system of claim 19, wherein the intensities of each of the plurality of pixels are set from intensities of the corresponding neighboring pixels.

22. The image system of claim 20, wherein the intensities of each of the plurality of pixels are set from intensities of the corresponding neighboring pixels.

23. The image system of claim 18, wherein the offsets are linear offsets.

24. The image system of claim 18, wherein the offsets are rotational offsets.

25. A method of generating a region of a higher resolution image, comprising:
receiving dimensions of a higher resolution image, wherein the higher resolution image is derived from a reference image and one or more images transposed from the reference image by corresponding offsets;
selecting pixel locations of a region of interest from the dimensions of the higher resolution image;
generating intensity values of each pixel in the region of interest in the higher resolution image by using the corresponding offsets; and
outputting the intensity values.

26. The method of claim 25, further comprising:
using the intensity values to perform one of edge detection, corner detection, or object recognition.
